(19) United States
(12) Patent Application Publication
(10) Pub. No.: US 2024/0190217 A1
(43) Pub. Date: Jun. 13, 2024

(54) AIR VENT, METHOD FOR MOUNTING AN AIR VENT, INSTRUMENT PANEL AND VEHICLE

(71) Applicant: Volkswagen Aktiengesellschaft, Wolfsburg (DE)

(72) Inventors: Robert OTTO, Braunschweig (DE); Ronny KNAUF, Beendorf (DE); Fabian REISS, Wolfsburg (DE); Marcus BUETTNER, Brome (DE)

(73) Assignee: Volkswagen Aktiengesellschaft, Wolfsburg (DE)

(21) Appl. No.: 18/533,885

(22) Filed: Dec. 8, 2023

(30) Foreign Application Priority Data
Dec. 8, 2022 (DE) 10 2022 213 315.3

(51) Int. Cl. B60H 1/34; B62D 65/00

(52) U.S. Cl. CPC B60H 1/34; B62D 65/00; B62D 25/142

(57) ABSTRACT

A method for mounting an air vent in an instrument panel of a vehicle. Provided is also an air vent for use in a vehicle, an instrument panel for use in a vehicle and a vehicle comprising at least one air vent and at least one instrument panel.

This nonprovisional application claims priority under 35 U.S.C. § 119(a) to German Patent Application No. 10 2022 213 315.3, which was filed in Germany on Dec. 8, 2022, and which is herein incorporated by reference.

### BACKGROUND OF THE INVENTION

### Field of the Invention

The invention relates to a an air vent, method for mounting an air vent, an instrument panel, and a vehicle.

### Description of the Background Art

To control the air quality as well as the temperature inside a vehicle, vehicles have a ventilation system. The introduction of an airflow from the ventilation system into the interior of the vehicle is carried out via one or more air vents. It is known from the conventional art that the air vents create an interface between the ventilation system and a user of the vehicle and often offer possibilities for at least partial regulation of the amount of air introduced into the interior by the air vent as well as the direction of flow. This can take place, e.g., via one or more adjustment elements (e.g., slats) of an air vent, which can be changed by a user in their orientation or position by means of a handle in order to influence the air flow.

Due to the arrangement of the air vents in the immediate vicinity of a user of the vehicle, their specific design and type of arrangement in the field of vision of a vehicle user plays an important role in the interior design of vehicles. Arranging air vents in or on trim parts of the vehicle, e.g., of an instrument panel (dashboard) is often done with the aim of integrating the air vents into the interior of the vehicle as homogeneously as possible. The decisive factor here is the design of the area of the air vent that is visible to a user in the intended installation position of the air vent. This applies in particular to the design of the vent opening and/or the design of areas that are adjacent to the vent opening. For example, it can be provided that, in addition to a vent opening, at least one area is provided which is visually modeled on a vent opening but does not function as such (decorative section). This can be done to visually enlarge the vent opening in order to achieve an advantageous overall impression in terms of the interior design of a vehicle. It also allows for the size of the vent opening to be varied depending on the vehicle or installation position if the area of a vent visible to a user is a constant size.

The design of a vent opening or the areas adjacent to the vent opening (e.g., decorative sections) of an air vent can be flexibly adapted to the respective vehicle concept. However, this may result in the dimensions of the vent opening deviating from the dimensions of other elements or components of the air vent, in particular those located behind the vent opening. For example, it may be provided that a flow housing is arranged behind the vent opening of an air vent, which, due to the adjustment elements arranged therein, cannot be varied in terms of its dimensions to the same extent as the vent opening of the air vent and is therefore larger or higher than the vent opening in at least one spatial dimension.

In order to be able to carry out maintenance and/or repair work on air vents or the ventilation system efficiently, it has also proven to be preferable to install air vents in such a way that they can be installed and/or removed, at least in part, independently of other trim elements of the vehicle. In this way, the amount of work required for maintenance or replacement of an air vent can be kept to a minimum. In order to be able to guarantee this, it is known from the state of the art to insert an air vent along a linear mounting direction into a mounting opening (e.g., in an interior trim of the vehicle) and then fix it there.

Since the dimensions of the required mounting opening in the respective trim part or between the adjacent trim parts must correspond at least to the maximum dimensions of the entire air vent and not only to the dimensions of the vent opening, once the air vent has been fastened, a panel is installed around the vent opening of the air vent in order to completely cover the mounting opening. With this mounting concept, it has proven to be a disadvantage that a single air vent in combination with the panel visually dominates a large area in the interior of the vehicle and, in addition, that the installation space occupied by the panel cannot be used sensibly by other control elements. In this way, modern ventilation concepts, such as, e.g., air vents with narrow or slotted vent openings do not integrate ideally into the vehicle interior and the associated advantages cannot be fully exploited.

### SUMMARY OF THE INVENTION

It is therefore an object of the present invention to provide a method as well as an air vent and an instrument panel that enable a simple, space-efficient and/or visually advantageous installation of an air vent in an instrument panel of a vehicle without having to accept losses in terms of maintenance and/or repair costs.

Features and details that are described in connection with the method according to the invention are of course also valid in connection with the air vent according to the invention and/or in connection with the instrument panel according to the invention and/or in connection with the vehicle according to the invention and vice versa in each case, so that reference is or can always be made reciprocally to the individual aspects of the invention with regard to the disclosure.

According to an example of the invention, a method for mounting an air vent in an instrument panel of a vehicle is provided, the method comprising at least: at least in part, inserting the air vent into a mounting opening of the instrument panel along a first mounting direction, wherein the mounting opening is limited, at least in sections, by an upper part of the instrument panel; moving the air vent along a second mounting direction different from the first, in particular towards the upper part of the instrument panel, so that a flow housing of the air vent is concealed, at least in sections, by the upper part of the instrument panel or is arranged at least in sections in an interior formed by the upper part of the instrument panel; rotating the air vent, in particular in the direction of the upper part of the instrument panel, about an axis of rotation so that a flow housing of the air vent is concealed, at least in sections, by the upper part of the instrument panel or is arranged at least in sections in an interior formed by the upper part of the instrument panel; centering the air vent on the instrument panel; and/or fixing the position of the air vent relative to the instrument panel.

In other words, according to the invention, it is provided that the air vent is first inserted, at least in part, along a first, preferably linear, mounting direction into a mounting opening provided for this purpose in the instrument panel or in the upper part of the instrument panel, wherein the mounting opening is at least in part limited by an upper part of an instrument panel of the vehicle. Within the scope of the invention, it is conceivable that the first mounting direction is oriented parallel or substantially parallel to the longitudinal axis of the vehicle. As a result, the air vent is first prepositioned in the mounting opening. In this position, a user of the vehicle would still be able to see parts of the flow housing of the air vent located behind the vent opening, in addition to the vent opening of the air vent. In order to completely hide the flow housing from a user of the vehicle, a circumferential panel would have to be placed around the vent opening of the air vent.

In order to arrange the flow housing at least in part invisible to a user and to be able to dispense with a panel, especially a circumferential one, the air vent is displaced according to the invention along a second, preferably linear, mounting direction, in particular in the direction of the upper part of the instrument panel. In this case, it may be provided that the second mounting direction is parallel or essentially parallel to the vehicle's vertical axis and/or orthogonal or essentially orthogonal to the first mounting direction. This brings the boundary of the vent opening of the air vent closer to the upper part of the instrument panel and further places the flow housing of the air vent at least in sections in an interior formed by the upper part of the instrument panel, so that the flow housing is at least partially concealed by the upper part of the instrument panel. Since the border or boundary of the vent opening is now located in the immediate vicinity of the upper part of the instrument panel or the flow housing is located at least in sections behind the upper part of the instrument panel, there is no need to place a circumferential panel around the vent opening of the air vent to hide the flow housing from a vehicle user. In addition, the arrangement of the vent opening in the immediate vicinity of the upper part of the instrument panel frees up additional installation space that would be taken up by a circumferential panel in the conventional installation of the air vent. This applies in particular to an area between the upper part of the instrument panel and the vent opening of the air vent.

As an alternative, or in addition to the displacement along the second mounting direction and in order to make the flow housing at least partially invisible to a user and to be able to dispense with a panel, it may be provided that the air vent rotates about an axis of rotation, in particular in the direction of the upper part of the instrument panel. It may be provided that the axis of rotation is parallel or substantially parallel to the vehicle's transverse axis and/or orthogonal or essentially orthogonal to the first and/or second mounting direction. The rotation allows for the flow housing to be inserted, at least in sections, into an interior formed by the upper part of the instrument panel and thus concealed by the upper part of the instrument panel. At the same time, the boundary of the vent opening of the air vent can thus be located in the immediate vicinity of the upper part of the instrument panel, eliminating the need for a circumferential panel around the vent opening to cover a gap between the instrument panel and the vent opening of the air vent. It is also conceivable within the scope of the invention that in order to carry out the rotation, the air vent, in particular the flow housing of the air vent, is placed at least in sections on a support of the instrument panel or another component of the vehicle.

At least in the context of the displacement of the air vent along the second mounting direction and/or the rotation of the air vent, according to the invention, the air vent is at least partially centered on the instrument panel, in particular on or relative to the upper part of the instrument panel, in order to at least in part set a position of the air vent relative to the upper part of the instrument panel. This has the advantage that the air vent is in the correct position relative to the upper part of the instrument panel before further fixation.

If the airflow device has been correctly positioned to the upper part of the instrument panel by centering, the position of the air vent relative to the instrument panel or the upper part of the instrument panel is fixed. Fixation may include the use of at least one fastener. In particular, at least one fastener may be designed as a screw or rivet. Fixation can also include the use of an adhesive or the creation of an adhesive bond.

The method according to the invention offers the advantage that even in the case of a narrow or slit-like vent opening of the air vent and a significant size difference between the vent opening and the flow housing of the air vent, the boundary of the vent opening can be located in the immediate vicinity of the instrument panel, i.e., the upper part of the instrument panel. As a result, there is no need for a subsequent arrangement of a panel that runs around the vent opening of the air vent or the panel to be used can be significantly reduced. Thus, a space-efficient and simple arrangement of the air vent on or in the instrument panel and an optimal integration of the air vent into the interior of the vehicle can be realized. It is also possible to easily dismantle the air vent in the event of maintenance and/or repair work without the need for time-consuming removal of the upper part of the instrument panel.

A vehicle's instrument panel may be located in the interior of the vehicle and is used to accommodate and/or visually frame various instruments or controls of the vehicle. The instrument panel is arranged in such a way that the driver and/or front passenger has access to the controls and instruments located on or in the instrument panel or can visually recognize them. An instrument panel, in particular the upper part of an instrument panel, may extend parallel or substantially parallel to the vehicle's transverse axis and/or over the entire or substantially entire width of the vehicle's interior in terms of its longitudinal extension. In particular, the upper end of the instrument panel is formed by an upper part of the instrument panel.

In the present case, a centering of the air vent is to be understood as the correct positioning of the air vent in relation to another component, in particular relative to the instrument panel or an upper part of the instrument panel.

It may be provided that the mounting opening is designed in the instrument panel, in particular in the upper part of the instrument panel. It is also conceivable within the scope of the invention that the mounting opening is completely limited by the instrument panel or the upper part of the instrument panel. Preferably, however, it may be provided that the instrument panel, in particular the upper part of the instrument panel, only bounds the mounting opening in sections. It is particularly preferred that at least the upper part of the mounting opening is limited by the instrument panel or the upper part of the instrument panel. Preferably, it may be provided that the mounting opening on at least one side, in particular at least on the lower side in relation to the vehicle's vertical axis, is unlimited or open.

Furthermore, it may be provided within the scope of the invention that the first mounting direction and the second mounting direction and/or the first mounting direction and the third mounting direction have an angle of inclination of at least 30°, in particular at least 50°, preferably at least 70°, especially preferably at least 80° or substantially 90° or exactly 90°. All values are given in angular degrees.

Within the scope of the invention, it may be provided that the vehicle is designed as a motor vehicle, in particular a car, a truck or a bus. It is also conceivable that the vehicle is designed as an agricultural utility vehicle or construction machine, in particular as a tractor, an excavator or similar. It may also be provided that the vehicle is an electric vehicle or that it is at least partially or fully electric. It is also conceivable that the vehicle is powered by hydrogen, at least partially or completely. It is also conceivable that the vehicle is powered by a hybrid drive system.

In the context of the invention, it is conceivable that the centering of the air vent on the instrument panel involves the insertion, at least in sections, of at least one centering agent arranged or formed on the air vent into a recess formed on the instrument panel, in particular on the upper part of the instrument panel. This makes it possible to create at least a partial form fit between the centering agent and the instrument panel, especially the upper part of the instrument panel. In other words, it may be provided that the movement of the air vent along the second mounting direction and/or the rotation of the air vent in the mounting opening brings at least one centering agent formed or arranged on the air vent into engagement, at least in sections, with a recess formed on or in the instrument panel, in particular in the upper part of the instrument panel. This creates at least a partial form fit between the air vent and the instrument panel, in particular the upper part of the instrument panel. The form fit may be designed in such a way that at least one degree of freedom of the air vent with respect to a movement of the air vent relative to the instrument panel or the upper part of the instrument panel is at least partially, in particular completely, blocked by the form fit. In particular, a movement, preferably translational, of the air vent relative to the instrument panel along a vehicle transverse axis and/or a vehicle longitudinal axis may be at least partially, in particular completely, blocked by the form fit. Alternatively or additionally, at least a rotation of the air vent relative to the instrument panel about a vehicle vertical axis and/or a vehicle longitudinal axis and/or a vehicle transverse axis may be at least partially, in particular completely, blocked by the form fit. By creating a form fit between the centering agent of the air vent and the instrument panel, the advantage is that the air vent is correctly positioned relative to the instrument panel in preparation for further fixation of the air vent. It may be provided within the scope of the invention that at least one, in particular all, recess(es) on the instrument panel, i.e., on the upper part of the instrument panel is or are arranged in an interior formed by the upper part of the instrument panel. In other words, it may be provided for at least one recess in the instrument panel, i.e., the upper part of the instrument panel to be located in an area not visible to a vehicle user.

It may be provided within the scope of the invention that at least one centering element and/or the air vent, in particular the flow housing of the air vent, at least one contact section is formed for at least partial contact with the instrument panel, i.e., the upper part of the instrument panel. With regard to a centering element, it may be provided that at least one contact section is designed as a circumferential contact section, in particular as a circumferential collar. It may further be provided that an insertion movement of at least one centering agent into a recess provided on the instrument panel, i.e., the upper part of the instrument panel, or the displacement of the air vent along the second mounting direction and/or the rotation of the air vent by one axis of rotation is limited by at least one contact section or at least partial contact between at least one contact section and the instrument panel, i.e., the upper part of the instrument panel. The contact section may also be formed by a surface of the air vent, in particular the flow housing of the air vent, wherein preferably at least one centering element is disposed on the respective surface. In other words, the centering element can only be inserted into the recess, in particular along a second mounting direction, until the contact section is at least sectionally in contact with the edge of the recess or with a surface of the instrument panel, in particular the upper part of the instrument panel, which surrounds the recess at least in sections. The second mounting direction can preferably be oriented parallel or essentially parallel to a vehicle's vertical axis.

Furthermore, it is conceivable within the scope of the invention that the centering of the air vent on the instrument panel involves the insertion at least in sections of several, in particular at least two, at least four, at least five or exactly five, centering agent into a recess formed on the instrument panel, i.e., on the upper part of the instrument panel, wherein in respect of each centering agent there is at least a partial form fit between the centering agent and the instrument panel, i.e., the upper part of the instrument panel. At least two centering agent, in particular all centering agent, may have at least one offset along the vehicle's transverse axis. The use of several centering agent has the advantage that an even more reliable positioning of the air vent relative to the instrument panel, i.e., the upper part of the instrument panel can be achieved.

It is conceivable within the scope of the invention that at least one centering agent has an excess with respect to a recess assigned to the centering agent on the instrument panel, i.e., the upper part of the instrument panel, so that at least partial plastic deformation of the centering agent is required for at least partial insertion of the centering agent into the recess. In this context, it may be provided that the centering agent is formed at least in sections from an elastic material, in particular one that can be reversibly deformed, or that it is sheathed with an elastic material. The elastic material can be an elastic polymer. The advantage of this is that by inserting the centering agent into the recess, a holding force is generated, which at least sectionally secures the air vent on the instrument panel as part of the installation of the air vent and thus simplifies the installation overall.

It may be provided within the scope of the invention that at least one centering agent is designed as a centering pin or a centering rib. It may be provided that a centering pin has a cylindrical shape and/or a cone-shaped or truncated cone-shaped end, at least in sections. In addition, it may be provided that a centering rib has an elongated shape, in particular rectangular or oval, at least in sections. The formation of a centering agent as a centering pin makes it particularly easy to insert the centering agent into a recess provided for this purpose on the instrument panel, i.e., the upper part of the instrument panel, since an insertion can take place, at least in part, independently of an angle of rotation of the air vent, in particular independently of an angle of rotation of the air vent about the vertical axis of the vehicle. The use of a centering rib, on the other hand, offers the advantage of better centering of the air vent on the instrument panel, i.e., the upper part of the instrument panel, since the form fit between the centering rib and the instrument panel also makes it possible to block a degree of rotational freedom with respect to a movement of the air vent relative to the instrument panel, i.e., the upper part of the instrument panel.

In particular, it may be provided that at least one centering agent is designed as a centering pin and at least one centering agent as a centering rib. It is also conceivable that the centering pin has a greater extension, in particular along the vertical axis of the vehicle, than the centering rib, so that when the air vent moves along the second mounting direction and/or the air vent rotates in the mounting opening, the centering pin is first inserted into a recess provided for this purpose on the instrument panel, i.e., the upper part of the instrument panel and only when the movement of the air vent progresses along the second mounting direction and/or a when a rotation of the air vent progresses in the mounting opening is the centering rib inserted into a recess provided for this purpose on the instrument panel, i.e., the upper part of the instrument panel. This results in the advantage of a particularly simple mounting of the air vent on the instrument panel, i.e., on the upper part of the instrument panel.

It may also be provided within the scope of the invention that in the mounting opening and/or on the instrument panel, i.e., on the upper part of the instrument panel at least one guide element provided for at least sectional guidance of the air vent when the air vent is inserted into the mounting opening along the first mounting direction. The guide element can limit the mounting opening, at least in sections, or form a boundary of the mounting opening. In particular, it may be provided that at least one guide element restricts the movement of the air vent within the mounting opening along a vehicle transverse axis. This has the advantage that when the air vent is inserted into the mounting opening, the air vent is prepositioned as well as possible with regard to subsequent movement along the second mounting direction and the associated centering of the air vent by at least one centering agent. In particular, it is conceivable that the centering agents are no longer visible to a user due to a movement of the air vent along the second mounting direction, whereby an appropriate prepositioning of the air vent in the mounting opening simplifies the installation overall.

It is also conceivable that fixing the position of the air vent involves securing the air vent against displacement of the air vent relative to the instrument panel, i.e., the upper part of the instrument panel along a third mounting direction or along the vehicle's vertical axis. It may be provided that the third mounting direction is oriented parallel or substantially parallel to the vehicle's vertical axis and/or opposite to the second mounting direction. In addition, it may be provided that the safety is provided by at least partial contact of the air vent, in particular at least one securing section of the air vent or the flow housing of the air vent, on at least one securing section of the instrument panel, in particular the upper part of the instrument panel, or another component of the vehicle. In other words, it may be provided that, once the air vent has been correctly positioned or centered in relation to the instrument panel, the air vent may be secured against unintentional displacement at least along a third mounting direction. It may be provided that the third mounting direction is oriented parallel or essentially parallel to the vehicle's vertical axis and/or opposite the second mounting direction. It may be provided that, in order to secure the air vent, the air vent, in particular the flow housing of the air vent and/or at least one securing section of the air vent, is or can be brought into at least partial contact or form fit with at least one securing section of the instrument panel, i.e., the upper part of the instrument panel. Due to the previous centering and the described securing against displacement along the third mounting direction, the advantage is that the air vent remains independently in its position relative to the instrument panel, i.e., to the upper part of the instrument panel, without additional securing (e.g., by a user) being required as part of the installation.

It may be provided for at least one securing section to be movable, in particular swiveling, at least sectionally relative to the air vent or the flow housing of the air vent. It may be provided that a movement or swivel of the securing section relative to that of the air vent or the flow housing is reversible, in particular without damaging the securing section. This gives the advantage of a simpler assembly process. The movability or swiveling can be realized, in particular by the shape and/or the material of the securing section. Preferably, it may be provided that the securing section, in particular at least one spring section of the securing section, is made of plastic, at least in sections, in particular completely. In addition, it may be provided that the securing section is designed at least in sections as a leaf spring element or a leaf spring and/or comprises at least one spring section. This means that a movement of the securing section by an application of force to the securing section, in particular to the spring section, generates a spring force and that the securing section is moved back to its original position by the spring force after the force has ceased to apply.

Furthermore, it is conceivable within the scope of the invention that the insertion of the air vent into the mounting opening along the first mounting direction is limited by at least partial contact between, on the one hand, at least one securing section of the air vent and/or the flow housing of the air vent, and, on the other hand, a securing section of the instrument panel or other component of the vehicle. In other words, the depth of insertion of the air vent into the mounting opening may be limited, in relation to movement of the air vent along the first mounting direction, by contact, at least in sections, between at least one securing section of the air vent or the flow housing of the air vent and at least one securing section of the instrument panel or upper part of the instrument panel or other component of the vehicle. This has the advantage of a defined insertion depth of the air vent in relation to the first mounting direction, which simplifies the subsequent insertion of centering elements of the air vent into dedicated recesses on the instrument panel due to better prepositioning.

It is also conceivable that fixing the position of the air vent involves creating at least one screw connection and/or latching connection and/or rivet connection and/or adhesive connection between, on the one hand, the air vent, in particular the flow housing and/or a securing section of the air vent, and, on the other hand, the instrument panel, in particular a securing section of the instrument panel and/or at least one other component of the motor vehicle, comprises. This has the advantage that the air vent reliably remains in place even under the influence of vibrations or acceleration forces that may result from the operation of the vehicle. In particular, it may be provided for at least one screw connection to be provided between at least one securing section of the air vent or the flow housing of the air vent and at least one securing section of the instrument panel or upper part of the instrument panel and/or a securing section of another component of the vehicle.

The above object is further achieved by an air vent according to the invention for use in a vehicle, in particular for mounting in an instrument panel of a vehicle. The air vent comprises at least one flow housing and at least one vent opening, with at least one centering agent for centering the air vent on an instrument panel of the vehicle being arranged or formed on the flow housing. It may also be provided within the scope of the invention that the air vent is designed to introduce an air flow into the interior of the vehicle. With regard to an air vent according to the invention, the same advantages arise as they have already been described in relation to a method according to the invention.

Furthermore, it may be provided within the scope of the invention that the air vent comprises at least one decorative section for the optical extension of a vent opening of the air vent. It can be provided that the decorative section is located in the immediate vicinity of the vent opening or directly adjacent to it. It may also be provided that at least two decorative sections are included, e.g., in order to visually lengthen or enlarge the vent opening in relation to two opposite directions. It may also be provided that at least one decorative section has a mounting section, with at least one centering agent on the mounting section for insertion, at least in sections, into a recess formed on the instrument panel, in particular on the upper part of the instrument panel, thereby creating at least a partial form fit between the decorative section and the instrument panel. It may also be provided that the mounting section is located invisibly to a user, at least if the air vent is mounted on the instrument panel, in particular on the upper part of the instrument panel. The advantage of using decorative sections is that the size of a vent opening of an air vent can be adjusted as needed without changing the appearance of the air vent to a user. In addition, an additional securing of the decorative sections on the instrument panel can be used to create a more stable connection between the air vent and the instrument panel.

In particular, it may be provided that the flow housing is larger than the vent opening in at least one dimension. Preferably, it can be provided that the flow housing has a greater extension than the vent opening, at least in relation to a vehicle vertical axis. This refers to the orientation of the air vent according to its intended installation position in relation to the vehicle.

The air vent may comprise at least one adjustment device, in particular at least one slat, for at least sectionally influencing the flow direction of an air flow that can be conducted out of the vent opening. Preferably, the air vent may comprise several, in particular at least two or at least three adjustment devices. At least one adjustment device may be at least partially movable in the air vent so that a user can influence the air flow introduced into the interior of the vehicle by the air vent by adjusting at least one adjustment device.

Furthermore, it may be provided within the scope of the invention that at least one centering agent can be connected to the air vent, in particular the flow housing of the air vent, in a material-tight manner. In particular, it may be provided that at least the flow housing of the air vent and at least one centering agent form a common, in particular monolithic, component and/or are manufactured as a common injection molded part. This results in the advantage of particularly simple and cost-efficient production.

With regard to the present invention, it is conceivable that at least one securing section can be formed on the flow housing for at least partial securing of the air vent against a displacement of the air vent relative to the instrument panel along a vehicle vertical axis or along a third mounting direction, wherein the third mounting direction is opposite to the second mounting direction and/or oriented. Within the scope of the invention, it is conceivable that at least one securing section is materially uniform and/or monolithic with the flow housing or forms an integral component with the flow housing. It may be provided that the flow housing and at least one securing section are designed as a common injection molded part. It may also be provided that the securing, at least in sections, of at least one securing section of the air vent or the flow housing of the air vent takes place by at least partial support on at least one securing section of the instrument panel, in particular the upper part of the instrument panel, or any other component of the vehicle. In other words, it is conceivable that the securing section of the air vent may be brought into at least partial contact and/or form fit with at least one securing section of the instrument panel, in particular the upper part of the instrument panel, and/or any other component of the vehicle, in order to achieve at least partial securing of the air vent against displacement along a third mounting direction, wherein in particular the third mounting direction is opposite the second mounting direction or oriented parallel or substantially parallel to the vehicle's vertical axis. By centering the air vent and the described securing against displacement along the third mounting direction, the air vent remains independently in its position relative to the instrument panel, i.e., the upper part of the instrument panel, without the need for additional securing (e.g., by a user) as part of an assembly.

Furthermore, it is conceivable that the air vent may be designed for use in a method according to a method according to the invention. This results in the same advantages as those already described in relation to a method according to the invention.

The above object is also achieved by an instrument panel according to the invention for use in a vehicle. The instrument panel comprises an upper part, wherein at least one mounting opening is provided in the instrument panel, in particular in the upper part of the instrument panel, wherein the mounting opening limited, at least in sections, by the upper part of the instrument panel. It may also be provided that the instrument panel is designed for use in a method according to the invention. An instrument panel according to the invention results in the same advantages as those already described in relation to the method according to the invention.

The above object is further achieved by a vehicle according to the invention, comprising at least one air vent, in particular at least one air vent according to the invention. Furthermore, the vehicle comprises at least one instrument panel, in particular at least one instrument panel according to the invention. It may be particularly preferably provided that at least one air vent is or has been mounted in the vehicle or in an instrument panel according to a method according to the invention. A vehicle according to the invention results in the same advantages as those already described in relation to a method according to the invention and/or an air vent according to the invention and/or an instrument panel according to the invention.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic view of an air vent according to the invention,

FIG. 2 shows a schematic representation of an instrument panel according to the invention,

FIG. 3 shows a schematic view of a vehicle according to the invention,

FIG. 4 shows a schematic representation of a method according to the invention,

FIG. 5 shows a schematic representation of the installation of an air vent in an instrument panel,

FIG. 6 shows a schematic representation of the installation of an air vent in an instrument panel,

FIG. 7 shows a schematic representation of the installation of an air vent in an instrument panel, and

FIG. 8 shows a schematic representation of the installation of an air vent in an instrument panel.

### DETAILED DESCRIPTION

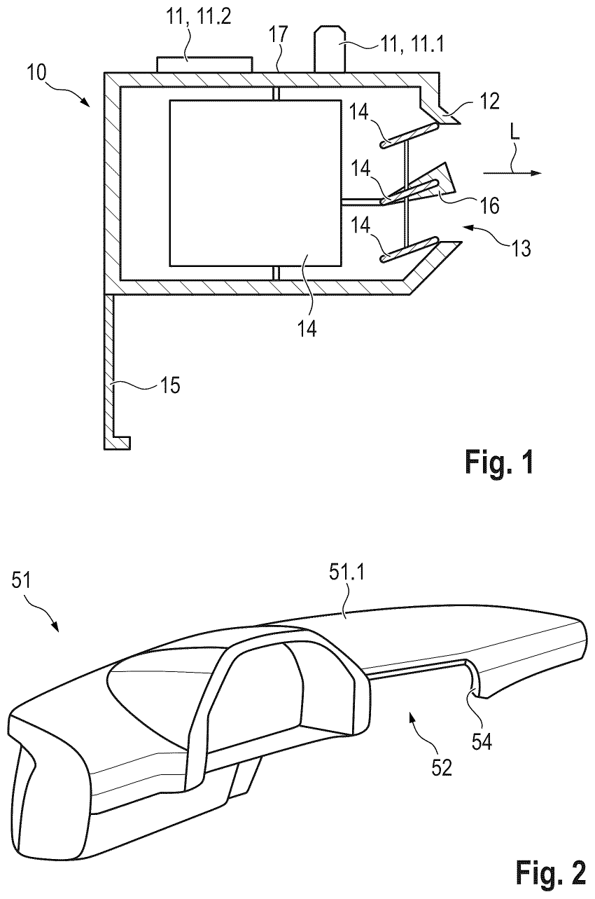

FIG. 1 shows a schematic view of an air vent 10 according to the invention for use in a vehicle 50. The air vent 10 comprises a flow housing 12 and at least one vent opening 13, wherein two centering agents 11 are arranged or formed on the flow housing 12 in the present case. FIG. 1 also shows that the flow housing 12 is larger than the vent opening 13 in at least one dimension.

The air vent 10 is designed to introduce an air flow L into the interior of a vehicle 50. In the process, the air flow L from the flow housing 12 is introduced into the interior of vehicle 50 through the vent opening 13.

The air vent 10 also comprises several adjustment devices 14 to at least partially influence the flow direction of an air flow L that can be discharged from the vent opening 13. The adjustment devices 14 are at least partially movable in the air vent 10, so that a user of the air vent 10 or of the vehicle 50 can adjust the position or orientation of at least one adjustment device 14 by means of the handle 16 in order to influence the air flow L introduced into the interior of the vehicle 50 through the air vent 10.

In the present case, the centering agents 11 are materially connected to the flow housing 12 and the flow housing 12 and the centering agents 11 are designed as a common injection molded part. In the present case, a centering agent 11 is formed as a centering pin 11.1 and has a cylindrical shape and a truncated cone-shaped end, at least in sections. Furthermore, a centering agent 11 is designed as a centering rib 11.2 and has an elongated, rectangular shape, at least in sections. Both centering devices 11 are arranged in such a way that they can be brought into engagement with the upper part 51.1 of an instrument panel 51 or brought into form fit at least in sections during the installation of the air vent 10.

In addition, a securing section 15 is formed on the flow housing 12 for an at least partial securing of the air vent 10 against a displacement of the air vent 10 relative to the instrument panel 51 along a vehicle vertical axis Z. For this purpose, the securing section 15 may be brought into at least partial contact with at least one securing section 54 of the instrument panel 51 and/or another component of vehicle 50. This is described in more detail below.

FIG. 2 shows a schematic view of an instrument panel 51 according to the invention. The instrument panel 51 comprises an upper part 51.1, wherein at least one mounting opening 52 is provided in the instrument panel 51, which is limited at least in sections by the upper part 51.1 of the instrument panel 51. In particular, the installation of an air vent 10 according to the invention can be carried out in the mounting opening 52 according to a method 100 according to the invention.

The mounting opening 52 is also limited laterally by at least one guide element 55, wherein the guide element 55 forms a boundary of the mounting opening 52. The guide element 55 restricts the movement of the air vent 10 within the mounting opening 52 along a vehicle transverse axis Y. This has the advantage that when the air vent 10 is inserted into the mounting opening 52, the air vent 10 is prepositioned as well as possible with regard to a subsequent movement along the second mounting direction 502 and the associated centering of the air vent 10.

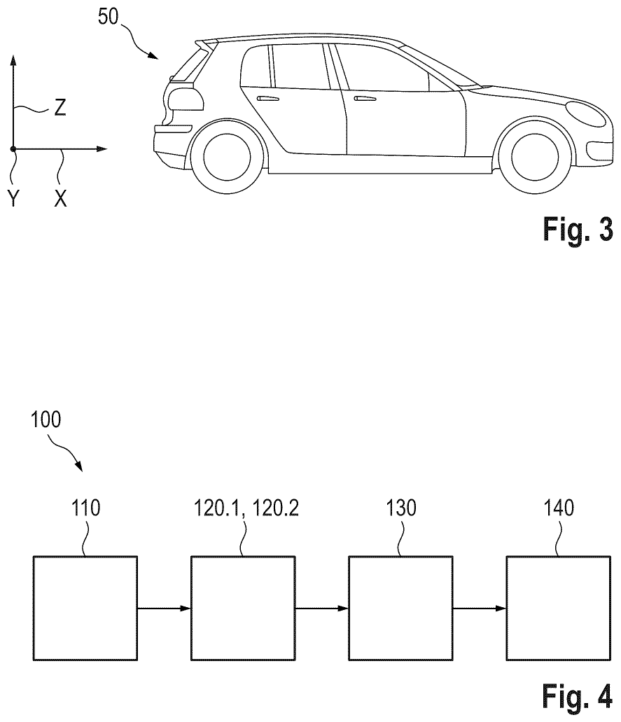

FIG. 3 also shows a vehicle 50 according to the invention which is designed as a car. The vehicle 50 comprises at least one air vent according to the invention 10 as well as at least one instrument panel according to the invention 51, wherein the air vent 10 was mounted in the instrument panel 51 according to a method 100 according to the invention.

FIG. 3 also shows the vehicle's longitudinal axis X, the vehicle's transverse axis Y, and the vehicle's vertical axis Z or their orientation in relation to the vehicle 50.

FIG. 4 shows a schematic view of a method 100 according to the invention, the method 100 comprising the following: at least partially inserting 110 the air vent 10 into a mounting opening 52 along a first mounting direction 501, wherein the mounting opening 52 is being limited at least in sections by an upper part 51.1 of the instrument panel 51, displacing 120.1 the air vent 10 along a second mounting direction 502, different from the first, in particular in the direction of the upper part 51.1 of the instrument panel 51, so that a flow housing 12 of the air vent 10 is concealed, at least in sections, by the upper part 51.1 of the instrument panel 51, or rotating 120.2 the air vent 10 about an axis of rotation R, in particular in the direction of the upper part 51.1 of the instrument panel 51, so that a flow housing 12 of the air vent 10 is concealed, at least in sections, by the upper part 51.1 of the instrument panel 51, centering 130 the air vent 10 on the instrument panel 51, fixing 140 the position of the air vent 10 relative to the instrument panel 51.

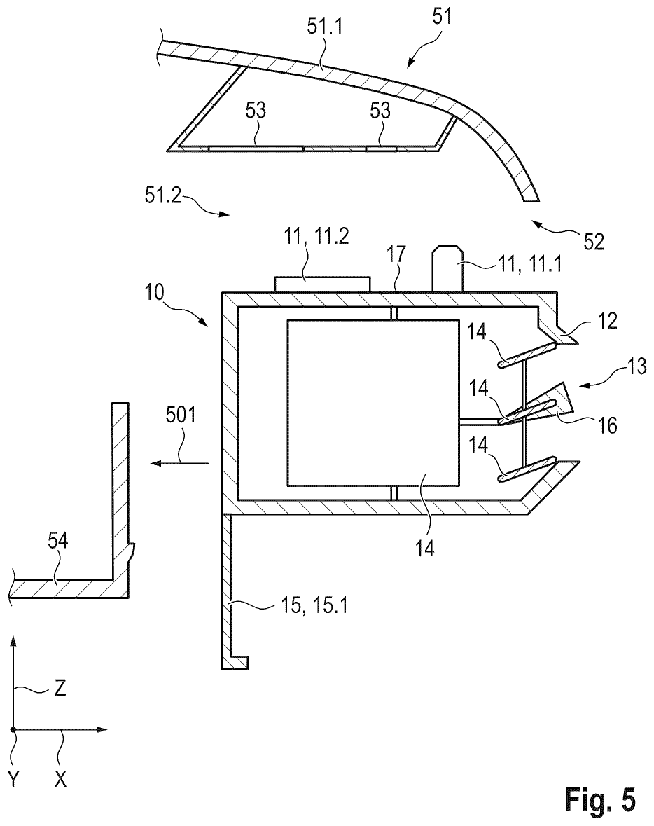

The individual aspects of the method 100 are explained below on the basis of various figures. FIG. 5 shows a schematic view of an air vent 10 according to the invention when mounted in an instrument panel 51, or an upper part 51.1 of the instrument panel 51, according to the invention.

As shown in FIG. 5, the first step is an at least partial insert 110 of the air vent 10 into a mounting opening 52 of the instrument panel 51, wherein the mounting opening 52 is limited, at least in sections, by the upper part 51.1 of the instrument panel 51. The insertion 110 is carried out along a first mounting direction 501, wherein the first mounting direction 501 is oriented parallel to the vehicle's longitudinal axis X.

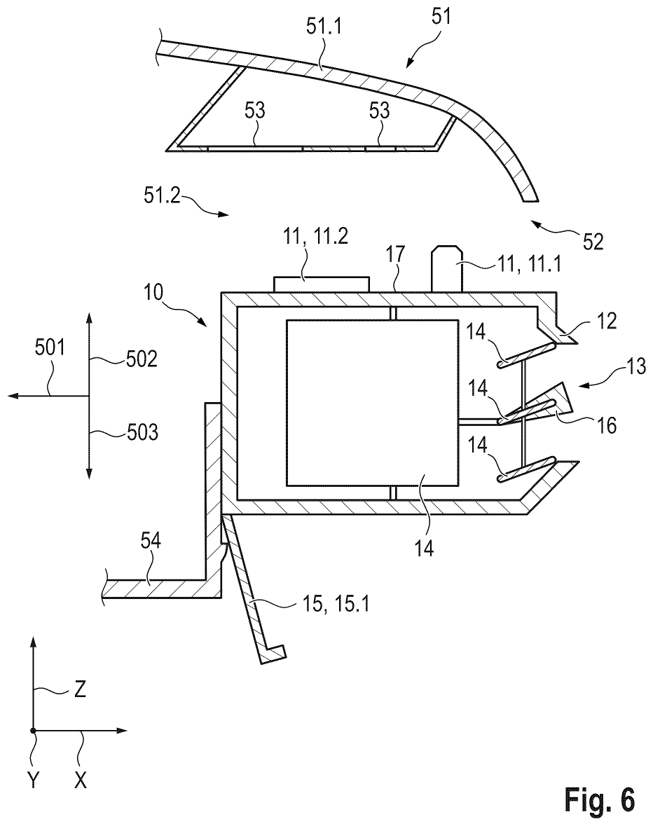

The insertion 110 of the air vent 10 into the mounting opening 52 along the first mounting direction 501 is limited, as shown in FIG. 6, by at least sectional contact between the flow housing 12 or the securing section 15 formed on the flow housing 12 and a securing section 54 of the instrument panel 51. It is also conceivable that the securing section 54 is formed by another component of the vehicle 50 instead of the instrument panel 51.

To ensure that the air vent 10 can be optimally prepositioned in the mounting opening 52, the securing section 15 of the air vent 10 is designed so as to, at least in part, swivel on the flow housing 12. In the present case, the securing element has a spring section 15.1 formed as a leaf spring for this purpose. As shown in FIG. 6, this makes it easier to preposition the air vent 10 in the mounting opening 52, thus facilitating the subsequent insertion of one or more centering agents 11 of the air vent 10 into recesses 53 provided for this purpose on the upper part 51.1 of the instrument panel 51.

After the air vent 10 has been prepositioned in the mounting opening 52 as shown in FIG. 6, the air vent 10 is displaced along a linear second mounting direction 502 in the direction of the upper part 51.1 of the instrument panel 51. The second mounting direction 502 is oriented orthogonally to the first mounting direction 501 and parallel to the vehicle's vertical axis Z.

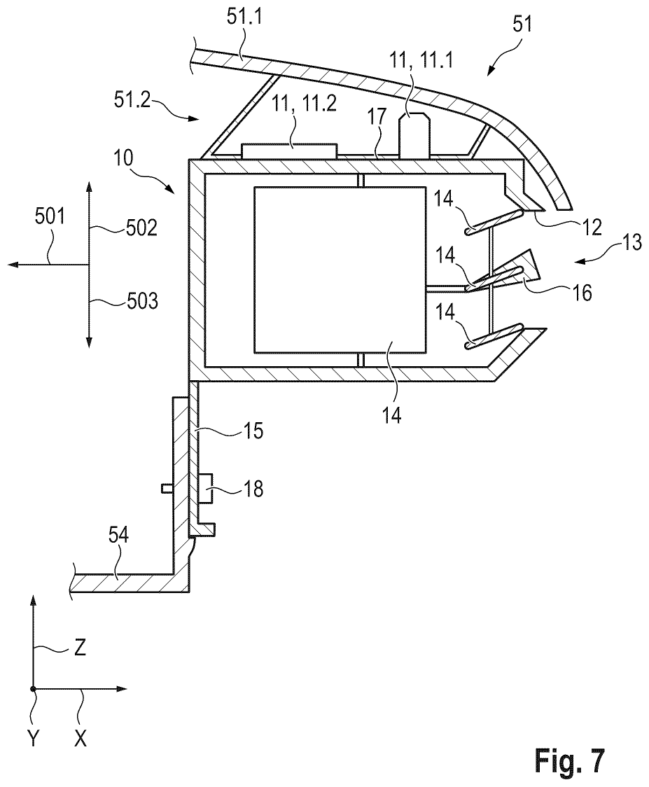

As can be seen from FIG. 7, this allows for the flow housing 12 to be arranged, at least in part, in an interior 51.2 formed by the upper part 51.1 of the instrument panel 51, so that the part of the flow housing 12 arranged in the interior 51.2 is not visible to a user of the vehicle 50. Thus, a narrow or slit-like vent opening 13 of the air vent 10 can also be located in the immediate vicinity of the instrument panel 51, in particular the upper part 51.1 of the instrument panel 51, if there is a significant difference in size between the vent opening 13 and the flow housing 12. Accordingly, the subsequent arrangement of a circumferential panel around the vent opening 13 of the air vent 10 can therefore be dispensed with.

It can also be seen from FIGS. 6 and 7 that, in the context of the displacement of the air vent 10 along the second mounting direction 502, the air vent 10 is centered on the upper part 51.1 of the instrument panel 51 in order to determine or fix, at least partially, a position of the air vent 10 relative to the upper part 51.1 of the instrument panel 51. For this purpose, at least one centering agent 11 arranged or formed on the air vent 10 is inserted at least in sections into a recess 53 provided for this purpose on the upper part 51.1 of the instrument panel 51. In the present case, two centering agents 11.1, 11.2 are inserted at least in sections into a recess 53 provided for this purpose on the upper part 51.1 of the instrument panel 51. This creates an at least partial form fit between the centering agents 11 and the instrument panel 51, i.e., the upper part 51.1 of the instrument panel 51.

The insertion of the centering agents 11 into the recesses 53 provided for this purpose is limited by the contact of a contact section 17 of the air vent 10, which in the present case is formed by the flow housing 12 or a surface of the flow housing 12 facing the upper part 51.1 of the instrument panel 51.

In order to fix the position of the air vent 10 relative to the upper part 51.1 of the instrument panel 51, the air vent 10 is also secured against a displacement of the air vent 10 relative to the upper part 51.1 of the instrument panel 51 along a third mounting direction 503, wherein the third mounting direction 503 is oriented in the opposite direction to the second mounting direction 502 and parallel to the vehicle's vertical axis Z.

According to FIG. 7, the securing is carried out in such a way that the securing section 15 of the air vent 10 is brought into at least a partial form fit with the securing section 54 of the instrument panel 51 (or any other component of the vehicle 50), whereby the air vent 10 is supported on the securing section 54 of the instrument panel 51 via the securing section 15 of the air vent 10.

As shown in FIG. 7, following the securing of the air vent 10, the air vent 10 is further fixed to or relative to the instrument panel 51 by making at least one screw connection (using a screw 18) between the securing section 15 of the air vent 10 and the securing section 54 of the instrument panel 51. As an alternative, the screw connection could also be made between the securing section 15 of the air vent 10 and another component of the vehicle 50.

It can also be seen from FIG. 6 that the centering pin 11.1 has a greater extension along the vehicle's vertical axis Z than the centering rib 11.2. Therefore, when the air vent 10 is moved along the second mounting direction 502, the centering pin 11.1 is first inserted into a recess 53 provided for this purpose on the instrument panel 51, i.e., the upper part 51.1 of the instrument panel 51. Only with a progressive movement of the air vent 10 along the second mounting direction 502 is the centering rib 11.2 inserted into a recess 53 provided for this purpose on the instrument panel 51, i.e., the upper part 51.1 of the instrument panel 51. This results in the advantage of a particularly simple mounting of the air vent 10 on the instrument panel 51, i.e., the upper part 51.1 of the instrument panel 51, since individual degrees of freedom of the air vent 10 are not blocked simultaneously but sequentially during the fixation.

The centering pin 11.1 is slightly oversized with respect to the recess 53 and is sheathed in a material that is at least partially elastic. This results in at least partial plastic deformation of the centering pin 11.1 when it is inserted into the recess 53. As a result, the centering pin 11.1 can be moved in the recess under the application of force (e.g., by a user during mounting), but as soon as the force is removed, the centering pin 11.1 does not slip out of the recess 52 independently due to the holding force generated in the context of the plastic deformation.

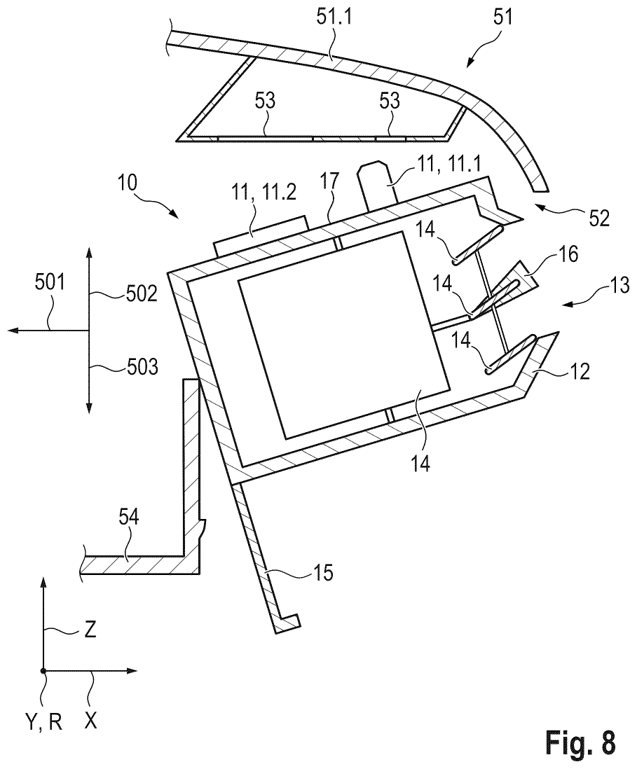

FIG. 8 also shows an arrangement of the air vent 10 in the mounting opening 52, wherein the air vent 10 has at least a rotational offset about an axis of rotation R as compared to the illustration in FIG. 5 or 6, wherein the axis of rotation R is oriented parallel to the vehicle transverse axis Y. FIG. 8 shows only the orientation of the axis of rotation R, but not its correct position in relation to the air vent 10 for the sake of simplicity. Accordingly, a rotation of the air vent 10 about the rotation axis R can be carried out from this position (possibly in conjunction with a displacement along the second mounting direction 502) in order to bring the air vent 10 into its intended position according to FIG. 7.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method to mount an air vent in an instrument panel of a vehicle, the method comprising:
at least partial insertion of the air vent into a mounting opening of the instrument panel along a first mounting direction, the mounting opening being limited, at least in sections, by an upper part of the instrument panel;
displacing the air vent along a second mounting direction different from the first mounting direction or a direction of the upper part of the instrument panel so that a flow housing of the air vent is concealed, at least in sections, by the upper part of the instrument panel, or rotating the air vent about an axis of rotation in the direction of the upper part of the instrument panel so that the flow housing of the air vent is concealed, at least in sections, by the upper part of the instrument panel;
centering the air vent on the instrument panel; and
fixing the position of the air vent relative to the instrument panel.

2. The method according to claim 1, wherein the centering of the air vent on the instrument panel involves an insertion, at least in sections, of at least one centering agent arranged on the air vent into a recess formed on the upper part of the instrument panel, thereby establishing at least a partial form fit between the centering agent and the instrument panel.

3. The method according to claim 2, wherein at least one centering agent is a centering pin or a centering rib.

4. The method according to claim 1, wherein the fixing of the position of the air vent involves securing the air vent against displacement along a third mounting direction, wherein the third mounting direction is oriented in the opposite direction to the second mounting direction, and wherein the securing is done by supporting, at least in sections, at least one securing section of the air vent or the flow housing of the air vent on a securing section of the instrument panel or any other component of the vehicle.

5. The method according to claim 1, wherein the insertion of the air vent into the mounting opening along the first mounting direction is limited by at least sectional contact between at least one securing section of the air vent and/or the flow housing of the air vent and a securing section of the instrument panel or other component of the vehicle.

6. The method according to claim 1, wherein the displacement of the air vent along the second mounting direction and/or the rotation of the air vent about the axis of rotation is limited by at least sectional contact between at least one contact section of the air vent and/or at least one contact section of at least one centering element and the upper part of the instrument panel.

7. The method according to claim 1, wherein the fixing of the position of the air vent involves making at least one screw connection and/or latching connection between the air vent and the instrument panel and/or between the air vent and at least one other component of the vehicle.

8. An air vent for a vehicle, the air vent comprising:
a flow housing;
at least one vent opening; and
at least one centering agent to center the air vent on an instrument panel of the vehicle, the at least one centering agent is formed on the air vent or the flow housing of the air vent.

9. The air vent according to claim 8, wherein the at least one centering agent is a centering pin or a centering rib.

10. The air vent according to claim 8, wherein at least one centering agent is materially connected to the air vent or the flow housing of the air vent.

11. The air vent according to claim 8, wherein at least one securing section is formed on the flow housing for at least partial securing of the air vent against a displacement of the air vent relative to the instrument panel along a third mounting direction, wherein the third mounting direction is oriented in an opposite direction to the second mounting direction, and wherein the securing is provided by at least partially supporting the securing section of the air vent on a securing section of the instrument panel or another component of the vehicle.

12. The air vent according to claim 8, the air vent comprising:
a flow housing;
at least one vent opening; and
at least one centering agent to center the air vent on an instrument panel of the vehicle, the at least one centering agent is formed on the air vent or the flow housing of the air vent
wherein the air vent is provided for the method according to claim 1.

13. An instrument panel for a vehicle, the instrument panel comprising:
an upper part;
at least one mounting opening provided in the instrument panel, the mounting opening being limited at least in sections by the upper part of the instrument panel,
wherein the instrument panel is adapted for the method according to claim 1.

14. A vehicle comprising at least one air vent and at least one instrument panel, wherein the air vent is mounted in the instrument panel according to the according to claim 1.
